(19) United States
(12) Patent Application Publication
(10) Pub. No.: US 2026/0337727 A1
(43) Pub. Date: Oct. 29, 2026

(54) PART MADE OF SILVER ALLOY

(71) Applicant: Omega SA, Biel/Bienne (CH)

(72) Inventors: Jonas VANNOD, Bienne (CH); Christian CHARBON, Chézard-St-Martin (CH); Gregory KISSLING, La Neuveville (CH)

(73) Assignee: Omega SA, Biel/Bienne (CH)

(21) Appl. No.: 19/636,026

(22) Filed: Apr. 1, 2026

(30) Foreign Application Priority Data
Apr. 23, 2025 (EP) 25171891.2

(51) Int. Cl. C22C 5/06; A44C 27/00

(52) U.S. Cl. CPC C22C 5/06; A44C 27/003

(57) ABSTRACT

A part made from a binary or ternary Ag alloy consisting, by weight for a total of 100%, of the following elements: between 92.5% and 95.5% of Ag; between 4.5% and 7.5% of Au for a binary alloy or between 4.5% and 7.5% in total of Au and of Pd for a ternary alloy; and possible impurities with a total content ≤0.50%.

### CROSS-REFERENCE TO RELATED APPLICATIONS

This application claims priority to European Patent Application No. 25171891.2, filed on Apr. 23, 2025, the entire contents of which are incorporated herein by reference.

### TECHNICAL FIELD OF THE INVENTION

The invention relates to a part, more specifically a horological component, made of a silver alloy.

### TECHNOLOGICAL BACKGROUND

Silver alloys are known to tarnish quickly. Parts made of silver are usually covered with a layer of Zapon or any other transparent coating to protect them from tarnishing and to keep the colour stable over time. However, such protection does not guarantee long-term stability, and the end result is more or less catastrophic tarnishing. The composition of the Ag alloy will have an impact on this propensity to tarnish over time, as will the colour before tarnishing, with a more or less pronounced whiteness.

### SUMMARY OF THE INVENTION

The present invention aims to provide a part made of a silver alloy with a pronounced whiteness and delayed tarnishing.

To this end, the present invention relates to a part made of a silver alloy comprising gold and optionally palladium.

More specifically, the invention relates to a part made of a binary or ternary Ag alloy. It is made of Ag and Au or it is made of Ag, Au and Pd, in both cases potentially with impurities.

More specifically, the invention relates to a part made from a binary or ternary Ag alloy consisting, by weight for a total of 100%, of the following elements:
between 92.5% and 95.5% of Ag,
between 4.5% and 7.5% of Au for a binary alloy or between 4.5% and 7.5% in total of Au and of Pd for a ternary alloy,
possible impurities with a total content s 0.50%.

All of the following percentage compositions will be expressed as a percentage by weight.

It has been observed that adding gold to the alloy surprisingly changes its colour. In fact, adding gold increases brightness, which lowers the yellowness index, making the alloy appear whiter. This whiteness is highly desirable in horological and jewellery applications.

Adding gold also has a beneficial effect because it helps to delay tarnishing. The addition of precious metals to replace less noble elements such as copper or zinc thus delays the tarnishing of silver alloy parts according to the invention.

The reduced hardness of these new alloys compared with alloys comprising copper or zinc can also be an additional advantage in terms of making it easier to form the alloy using various distortion methods, such as stamping, forging or pressing. Reduced hardness can also make it easier to inlay other decorative elements such as stones, powders or alloys to make composite parts. After distortion, the various alloys attain hardnesses in excess of 90 HV, which is sufficient to produce decorative horological parts.

### BRIEF DESCRIPTION OF THE FIGURES

FIG. 1 is a graph of the results of tarnishing tests in a tropical climate over time for two Ag alloys according to the invention and two reference Ag alloys.

FIG. 2 shows part of a dial with decorative elements representing the moon phase.

### DETAILED DESCRIPTION OF THE INVENTION

The invention relates to a part made from a binary or ternary Ag alloy. The alloy used in the present invention is an Ag alloy with a fineness of 925 per thousand by weight.

According to the invention, the binary alloy consists by weight of Ag in a range comprised between 92.5% and 95.5%, of Au in a range comprised between 4.5% and 7.5% and of possible impurities with a total content less than or equal to 0.50%. The alloy is made of these various elements and impurities, meaning that all of the Ag, Au and any impurities combined make up 100%. Preferably, the Au content is comprised between 6% and 7.5%, more preferentially between 6.7% and 7.3%, even more preferentially between 6.9% and 7.1%.

According to the invention, the ternary alloy is made of Ag in a range comprised between 92.5% and 95.5%, of Au and of Pd with a total content for Au and Pd comprised in the range between 4.5% and 7.5% and of possible impurities with a total content of less than or equal to 0.50%. The alloy is made of these various elements and impurities, meaning that all of the Ag, of the Au, of the Pd and of any impurities combined make up 100%. Preferably, the Au content and the Pd content are respectively comprised between 1.5% and 5.5% with a total for Au and Pd comprised between 6% and 7.5%. More preferentially, the Au content is comprised between 3% and 5.5% and the Pd content is comprised between 1.5% and 4% with a total for Au and Pd comprised between 6% and 7.5%. Particularly preferably, the Au content is comprised between 4.5% and 5.5% and the Pd content is comprised between 1.5% and 2.5% with a total for Au and Pd comprised between 6.5% and 7.5%. Even more particularly preferably, the Au content is comprised between 4.7% and 5.3%, preferably between 4.9% and 5.1%, and the Pd content is comprised between 1.7% and 2.3%, preferably between 1.9% and 2.1%, with a total for Au and Pd comprised between 6.7% and 7.3%, preferably between 6.9% and 7.1%.

Alloys according to the invention have a hardness HV2 comprised between 30 and 50 after annealing and a yellowness index Yi10° as defined hereinafter comprised between 2 and 9.5, preferably between 2.5 and 6.

Ag alloys according to the invention are particularly suitable for manufacturing horological components and, more specifically, inner external parts such as dials, dial indexes and moon phases, for example. By way of example, FIG. 2 shows a dial 1 with a moon disc 2 made of an Ag alloy according to the invention, with a decoration created, for example, by lacquering. In general, this alloy can be used for any part and more specifically any decorative part, for example, in the field of jewellery, such as lockets, cufflinks, etc.

To prepare the silver alloy according to the invention, proceed as follows. The main elements used to make the alloy have a purity of between 999 and 999.9 parts per thousand and are deoxidized. The elements used to make the alloy are placed in a crucible, which is then heated until the elements melt. The molten alloy is cast into an ingot mould or into bars with round, rectangular, or contoured cross-sections. After solidification, the ingot is water-hardened if it was cast in an ingot mould. The hardened ingot or bar is then cold rolled and annealed. The cold working rate between each annealing is from 10% to 90%. Each annealing takes between 15 minutes and 3 hours at a temperature comprised between 550 °C and 800 °C in a reducing H₂ and/or N₂ atmosphere. After annealing, the parts are cooled by hardening them in water.

The colorimetric values and hardness of various alloys according to the invention, prepared using the method described above, are presented in Table 1 along with comparative examples. The compositions of the comparative examples are free of Au and some contain Cu or Zn. Measurements were taken on annealed and polished samples. At the same time, tarnish resistance tests under tropical climate conditions were conducted on samples 1, 2 and 6, 7. The tests were conducted in a programmable climate-controlled chamber at a relative humidity of 93%±5% achieved using a solution of demineralized water, and at a temperature of 50 °C±2 °C. The ΔE00, which is a measure of the colour difference between the samples after testing under tropical conditions and before such testing, was calculated using the formula specified in ISO 12647-2:2013.

The L*a*b* colorimetric values in the CIELAB colour space (in accordance with CIE Standard No. 15, ISO 7724/1, DIN 5033 Part 7, ASTM E-1164) were measured using a KONICA MINOLTA CM-2600d spectrophotometer with a D65 illuminant and a viewing angle of 10°. The Yellowness Index Yi10°, which is an indicator of the alloy's whiteness, was calculated based on L*a*b* values in accordance with ASTM E313. The lower the index, the whiter the alloy.

TABLE 1
(expressed by weight relative to a total of 1,000)

| | | Composition | | | | | Colorimetry | | | | |
|---|---|---|---|---|---|---|---|---|---|---|---|
| | No. | Au | Pd | Ag | Cu | Zn | L | a* | b* | Yi10° | HV2 |
| Invention | 1 | 70.0 | / | 930.0 | / | / | 98.56 | 0.12 | 1.41 | 2.69 | 38 |
| | 2 | 50.0 | 20.0 | 930.0 | / | / | 97.32 | 0.47 | 2.88 | 5.72 | 39 |
| | 3 | 35.0 | 35.0 | 930.0 | / | / | 95.83 | 0.79 | 4.14 | 8.37 | 41 |
| | 4 | 20.0 | 50.0 | 930.0 | / | / | 95.19 | 1.06 | 4.54 | 9.36 | 41 |
| Comparative | 5 | / | 70.0 | 930.0 | | | 94.17 | 1.38 | 4.98 | 10.51 | 43 |
| | 6 | / | / | 925.0 | 75 | / | 97.00 | 0.1 | 4.5 | 8.41 | 70 |
| | 7 | / | 12 | 941.0 | / | 47 | 96.8 | −0.3 | 4.2 | 7.57 | 70 |

It can be observed that as the Au content increases, the Yellowness Index decreases, with a more marked decrease for Au contents of 7% and 5% by weight in samples 1 and 2. Contents of 2% and 3.5% already provide a slight improvement over the reference sample 5 comprising Pd.

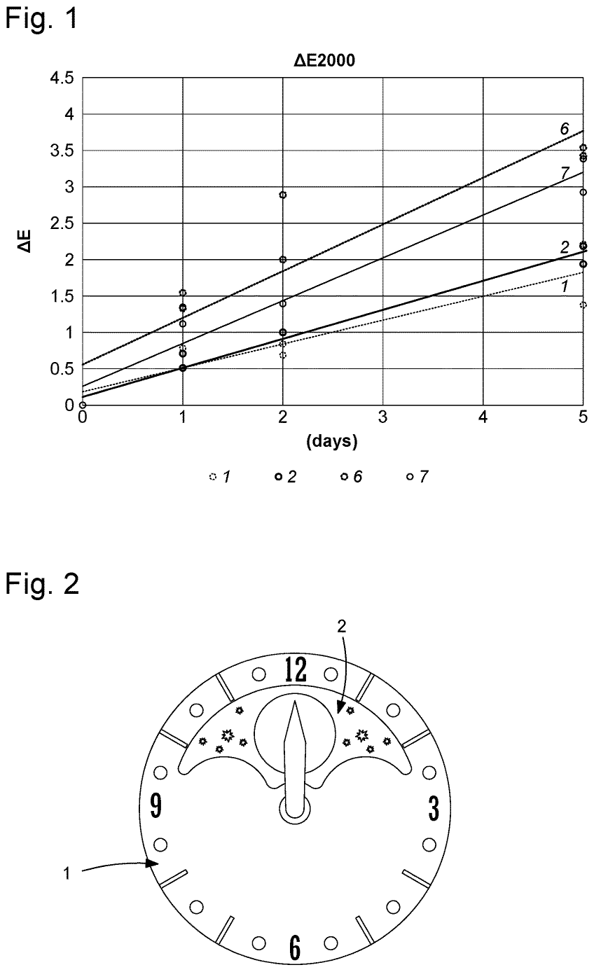

With regard to the tarnishing tests, FIG. 1 shows improved resistance to tarnishing for samples 1 and 2 compared with samples 6 and 7, with an improvement that tends to be more marked for sample 1 comprising 7% of Au.

1. A part made from a binary or ternary Ag alloy consisting, by weight for a total of 100%, of the following elements:
between 92.5% and 95.5% of Ag,
between 4.5% and 7.5% of Au for a binary alloy or between 4.5% and 7.5% in total of Au and of Pd for a ternary alloy,
possible impurities with a total content s 0.50%.

2. The part according to claim 1, in which, for a binary alloy, relative to the total weight of the alloy, the Au content is comprised between 6% and 7.5%, preferably between 6.7% and 7.3%, more preferentially between 6.9% and 7.1%.

3. The part according to claim 1, in which, for a ternary alloy, relative to the total weight of the alloy, the Au content and the Pd content are respectively comprised between 1.5% and 5.5% with a total for Au and Pd comprised between 6% and 7.5%.

4. The part according to claim 3, in which, for a ternary alloy, relative to the total weight of the alloy, the Au content is comprised between 3% and 5.5% and the Pd content is comprised between 1.5% and 4% with a total for Au and Pd comprised between 6% and 7.5%.

5. The part according to claim 4, in which, for a ternary alloy, relative to the total weight of the alloy, the Au content is comprised between 4.5% and 5.5% and the Pd content is comprised between 1.5% and 2.5% with a total for Au and Pd comprised between 6.5% and 7.5%.

6. The part according to claim 5, in which, for a ternary alloy, relative to the total weight of the alloy, the Au content is comprised between 4.7% and 5.3%, preferably between 4.9% and 5.1%, and the Pd content is comprised between 1.7% and 2.3%, preferably between 1.9% and 2.1%, with a total for Au and Pd comprised between 6.7% and 7.3%, preferably between 6.9% and 7.1%.

7. The part according to claim 1, said part being a horological component or a jewellery component.

8. The part according to claim 7, said part being an element (2) indicating the moon phase.

9. The part according to claim 1, said part having a yellowness index Yi10° comprised between 2 and 9.5, preferably between 2.5 and 6.
